(19) United States
(12) Patent Application Publication
(10) Pub. No.: US 2010/0139728 A1
(43) Pub. Date: Jun. 10, 2010

(54) FOLDABLE TENT

(76) Inventor: Chuen-Jong TSENG, Chiayi Hsien (TW)

Correspondence Address: LADAS & PARRY LLP, 224 SOUTH MICHIGAN AVENUE, SUITE 1600, CHICAGO, IL, 60604, US

(21) Appl. No.: 12/327,890

(22) Filed: Dec. 4, 2008

(51) Int. Cl. E04H 15/48; F16H 21/18

(52) U.S. Cl. 135/144; 74/49

(57) ABSTRACT

A foldable tent includes a frame unit, a driven mechanism, and a driving mechanism. The frame unit includes first and second upright posts, and a connecting rod rotatably interconnecting the first and second upright posts. The driven mechanism includes two supporting units, and two tent covers, each of which has a first securing portion connected fixedly to the connecting rod, and a second securing portion connected fixedly to a respective one of the supporting units. The driven mechanism is convertible between an unfolded state, where the tent covers are unwound, and a folded state, where the tent covers are wound on the connecting rod. The driving mechanism is mounted on the frame unit for driving the connecting rod to rotate to thereby convert the driven mechanism between the unfolded and folded states.

### BACKGROUND OF THE INVENTION

1. Field of the Invention

The invention relates to a tent, more particularly to a foldable tent.

2. Description of the Related Art

Tents are generally used in outdoor activities for protection against rain and the sun. A conventional tent usually comprises a supporting frame unit, a tent cover covering on the supporting frame unit, and a plurality of fastening ropes for securing the tent cover on the supporting frame unit. When assembling the conventional tent, the supporting frame unit has to be erected first. Then, the tent cover is placed on the supporting frame unit. Finally, the fastening ropes are applied individually to secure the tent cover on the supporting frame unit. After use, the fastening ropes and the tent cover have to be removed from the supporting frame unit, and the supporting frame unit has to be disassembled, so as to facilitate storage and transport of the conventional tent. However, the assembling and disassembling processes are relatively time-consuming and inconvenient.

### SUMMARY OF THE INVENTION

Therefore, the object of the present invention is to provide a foldable tent that is relatively easy to fold and unfold.

Accordingly, a foldable tent of the present invention comprises a frame unit, a driven mechanism, and a driving mechanism. The frame unit includes a first upright post, a second upright post spaced apart from the first upright post, and a connecting rod extending in a first horizontal direction and rotatably interconnecting top ends of the first and second upright posts. The driven mechanism includes first and second movable seats, a pair of elongate, flexible connecting components, a pair of supporting units, and a pair of tent covers. The first and second movable seats are disposed on and movable along the first and second upright posts, respectively. Each of the connecting components interconnects a respective one of the first and second movable seats and the connecting rod of the frame unit. The supporting units are spaced apart from each other in a second horizontal direction transverse to the first horizontal direction. Each of the supporting units includes a first side rod that has a pivot end connected pivotally to the first movable seat and a connecting end opposite to the pivot end of the first side rod, a second side rod that is parallel to the first side rod and that has a pivot end connected pivotally to the second movable seat and a connecting end opposite to the pivot end of the second side rod, and a linking rod that is parallel to the connecting rod of the frame unit and that interconnects the connecting ends of the first and second side rods. The tent covers are disposed on the frame unit. Each of the tent covers has a first securing portion that is connected fixedly to the connecting rod of the frame unit, and a second securing portion that is connected fixedly to the linking rod of a respective one of the supporting units. The driven mechanism is convertible between an unfolded state, where the first and second movable seats are proximate to the connecting rod of the frame unit and where the connecting ends of the first and second side rods of the supporting units are far away from the connecting rod of the frame unit so as to unwind the tent covers, and a folded state, where the first and second movable seats are distal from the connecting rod of the frame unit and where the connecting ends of the first and second side rods are adjacent to the connecting rod of the frame unit so as to wind the tent covers on the connecting rod of the frame unit. The driving mechanism is mounted on the frame unit for driving the connecting rod of the frame unit to rotate, thereby resulting in conversion of the driven mechanism between the unfolded and folded states.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of a foldable tent according to the invention;

FIG. 2 is a side view of the preferred embodiment, illustrating a driven mechanism in an unfolded state;

FIG. 3 is another side view of the preferred embodiment, illustrating the driven mechanism in a folded state;

FIG. 4 is a fragmentary sectional view of the preferred embodiment, illustrating a driving mechanism thereof;

FIG. 5 is a fragmentary perspective view of the preferred embodiment; and

FIG. 6 is a fragmentary side view of the preferred embodiment.

### DETAILED DESCRIPTION OF THE PREFERRED EMBODIMENT

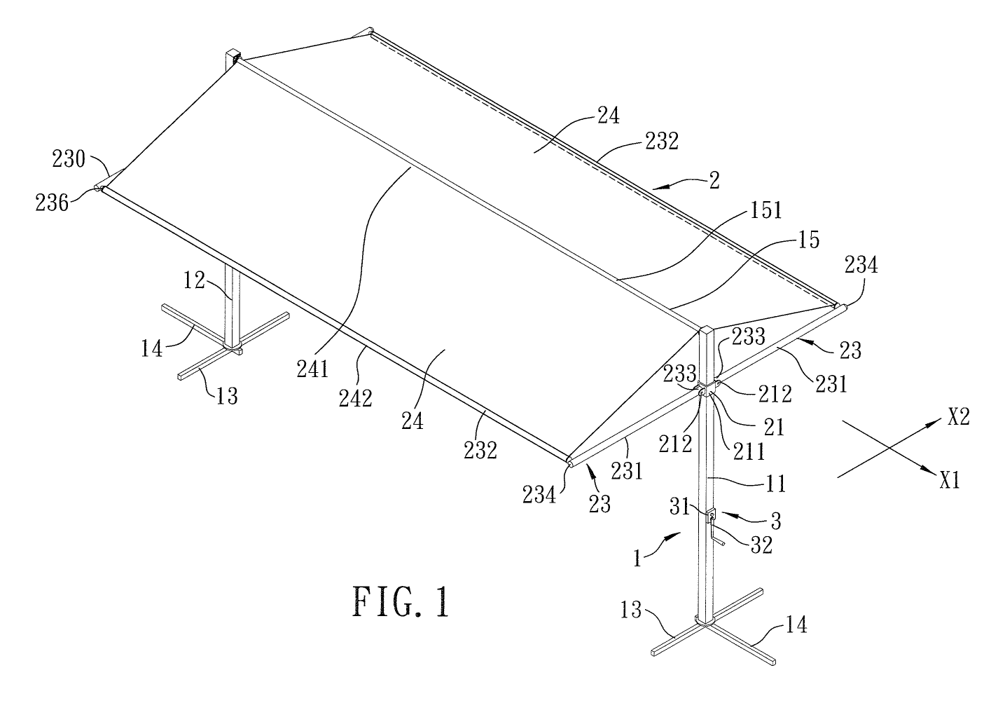

As shown in FIGS. 1 to 4, the preferred embodiment of a foldable tent according to the present invention comprises a frame unit 1, a driven mechanism 2, and a driving mechanism 3.

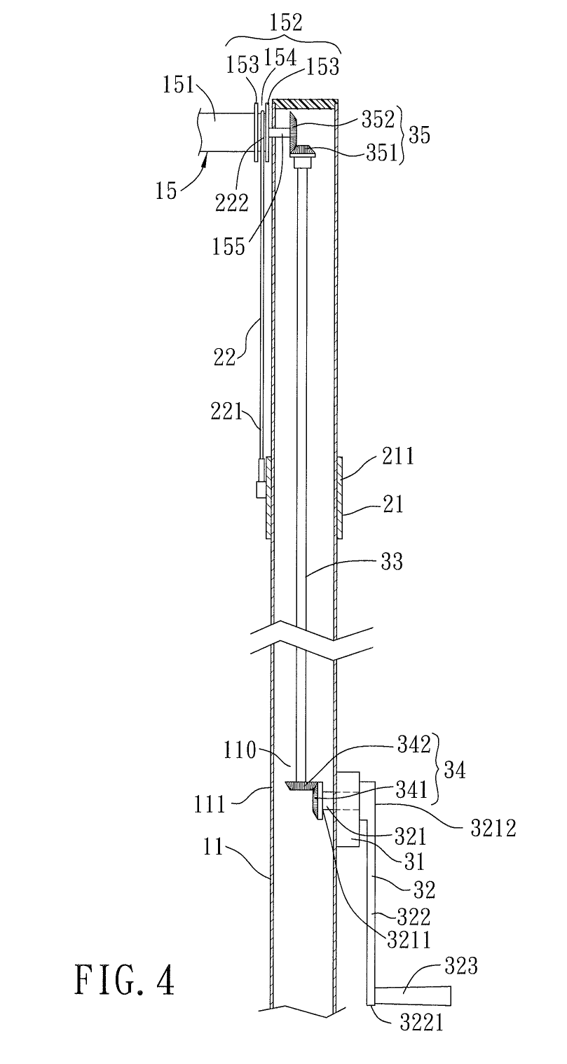

The frame unit 1 includes a first upright post 11, a second upright post 12 that is spaced apart from the first upright post 11, a connecting rod 15 that extends in a first horizontal direction (X1) and that rotatably interconnects top ends of the first and second upright posts 11, 12, a pair of bottom rods 13 that are connected respectively to bottom ends of the first and second upright posts 11, 12 and that extend in a second horizontal direction (X2) transverse to the first horizontal direction (X1), and a pair of extending rods 14 that are connected respectively to bottom ends of the first and second upright posts 11, 12 and that extend in the first horizontal direction (X1). In this embodiment, each of the first and second upright posts 11, 12 includes a hollow post body 111 that has a rectangular cross-section and that defines a receiving space 110 therein. The connecting rod 15 has opposite rod ends 155 (only one is visible in FIG. 4) connected rotatably and respectively to the top ends of the first and second upright posts 11, 12, and a main rod portion 151 disposed between the first and second upright posts 11, 12. Each of the rod ends 155 extends rotatably into the receiving space 110 in a respective one of the first and second upright posts 11, 12. The connecting rod 15 further has a pair of engaging portions 152, each of which is disposed between the main rod portion 151 and a respective one of the rod ends 155, and is disposed proximate to the respective one of the rod ends 155. As best shown in FIG. 4, each of the engaging portions 152 includes a pair of outward flanges 153 that are spaced apart from each other in the first horizontal direction (X1), and that cooperatively define an annular groove 154 therebetween.

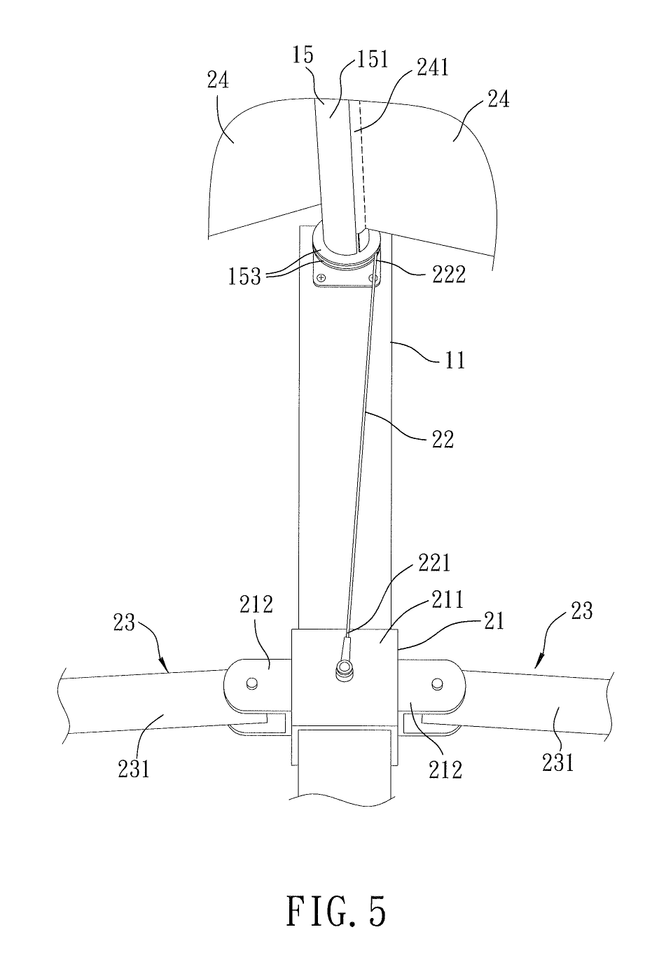

With further reference to FIG. 5, the driven mechanism 2 includes first and second movable seats 21, 20, a pair of elongate, flexible connecting components 22, a pair of supporting units 23, and a pair of tent covers 24.

The first and second movable seats 21, 20 are disposed on and movable along the first and second upright posts 11, 12 of the frame unit 1, respectively. The first movable seat 21 has a sleeve portion 211 sleeved movably on the first upright post 11, and a pair of pivot lug portions 212 projecting respectively from opposite sides of the sleeve portion 211 in the second horizontal direction (X2). Similarly, the second movable seat 20 has a sleeve portion 201 sleeved movably on the second upright post 12, and a pair of pivot lug portions 202 projecting respectively from opposite sides of the sleeve portion 201 in the second horizontal direction (X2).

Each of the connecting components 22 interconnects a respective one of the first and second movable seats 21, 20 and the connecting rod 15 of the frame unit. In this embodiment, each of the connecting components 22 is a wire rope, and has a first section 221 that is connected to the respective one of the first and second movable seats 21, 20, and a second section 222 that is retained in the annular groove 154 in a respective one of the engaging portions 152 of the connecting rod 15 of the frame unit 1.

The supporting units 23 are connected pivotally and respectively to opposite sides of the frame unit 1 and are spaced apart from each other in the second horizontal direction (X2). Each of the supporting units 23 includes a first side rod 231 having a pivot end 233 that is connected pivotally to a respective one of the pivot lug portions 212 of the first movable seat 21, and a connecting end 234 that is opposite to the pivot end 233, a second side rod 230 parallel to the first side rod 231 and having a pivot end 235 that is connected pivotally to a respective one of the pivot lug portions 202 of the second movable seat 20, and a connecting end 236 that is opposite to the pivot end 235, and a linking rod 232 parallel to the connecting rod 15 of the frame unit 1 and interconnecting the connecting ends 234, 236 of the first and second side rods 231, 230. As such, the pivot lug portions 212 of the first movable seat 21 are connected pivotally and respectively to the pivot ends 233 of the first side rods 231 of the supporting units 23, and the pivot lug portions 202 of the second movable seat 20 are connected pivotally and respectively to the pivot ends 235 of the second side rods 230 of the supporting units 23.

The tent covers 24 are disposed on the frame unit 1. In this embodiment, each of the tent covers 24 is made of waterproof material, is in a form of a rectangular sheet, and has a first securing portion 241 that is connected fixedly to the connecting rod 15 of the frame unit 1, and a second securing portion 242 that is connected fixedly to the linking rod 232 of a respective one of the supporting units 23.

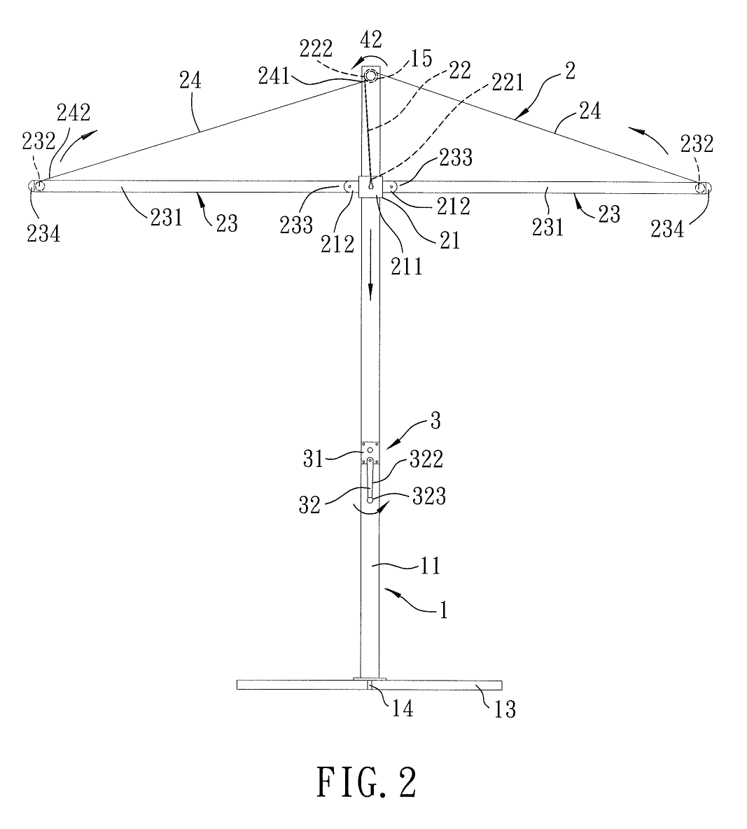

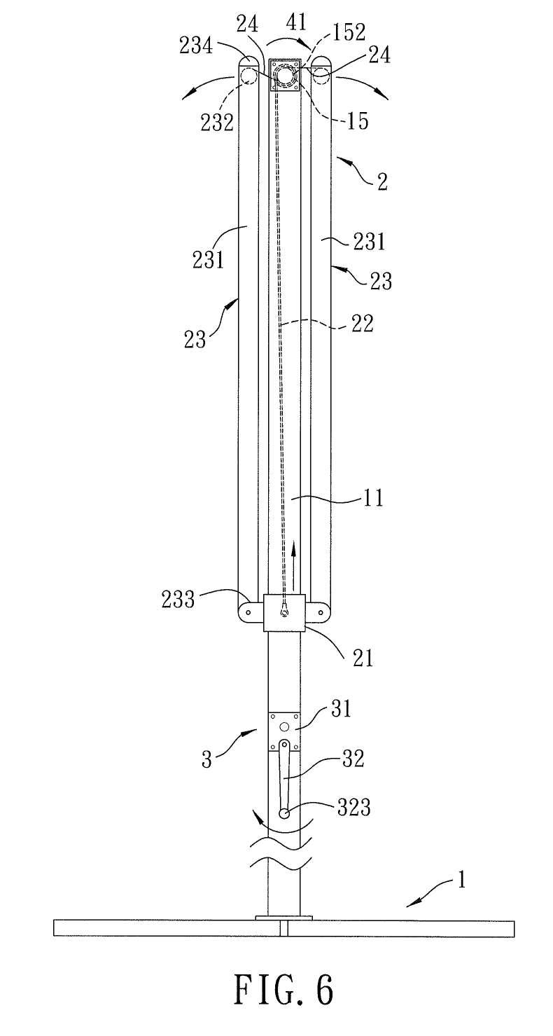

The driven mechanism 2 is convertible between an unfolded state (see FIGS. 1 and 2), where the first and second movable seats 21, 20 are proximate to the connecting rod 15 of the frame unit 1 and where the connecting ends 234, 236 of the first and second side rods 231, 230 of the supporting units 23 are far away from the connecting rod 15 so as to unwind the tent covers 24, and a folded state (see FIGS. 5 and 6), where the first and second movable seats 21, 20 are distal from the connecting rod 15 and where the connecting ends 234, 236 of the first and second side rods 231, 230 of the supporting units 23 are adjacent to the connecting rod 15 so as to wind the tent covers 24 on the connecting rod 15.

As best shown in FIG. 4, the driving mechanism 3 is mounted on the frame unit 1 for driving the connecting rod 15 of the frame unit 1 to rotate, thereby resulting in conversion of the driven mechanism 2 between the unfolded and folded states. The driving mechanism 3 includes a mounting seat 31 mounted on the post body 111 of the first upright post 11 of the frame unit 1, a driving member 32 mounted on the mounting seat 31 and extending rotatably into the receiving space 110 in the first upright post 11, a transmission shaft 33 disposed uprightly and rotatably in the receiving space 110, a first gear unit 34 connecting co-rotatably the driving member 32 to a bottom end of the transmission shaft 33, and a second gear unit 35 connecting co-rotatably a top end of the transmission shaft 33 to a corresponding one of the rod ends 155 of the connecting rod 15 of the frame unit 1.

The driving member 32 has a driving section 321, a connecting section 322, and a handle section 323. The driving section 321 has a first end 3211 that extends rotatably and horizontally into the receiving space 110 in the post body 111 of the first upright post 11 of the frame unit 1, and that is connected to the first gear unit 34, and a second end 3212 that is exposed from the mounting seat 31. The connecting section 322 extends uprightly from the second end 3212 of the driving section 321 and has a distal end 3221 that is opposite to the driving section 321. The handle section 323 extends horizontally from the distal end 3221 of the connecting section 322 in a direction away from the driving section 321, and is operable for driving the driving member 32 to rotate.

The first gear unit 34 includes a first gear 341 connected fixedly to the driving member 32, and a second gear 342 connected fixedly to the bottom end of the transmission shaft 33 and meshing with the first gear 341. The second gear unit 35 includes a third gear 351 connected fixedly to the top end of the transmission shaft 33, and a fourth gear 352 connected fixedly to the corresponding one of the rod ends 155 of the connecting rod 15 of the frame unit 1. In this embodiment, each of the first, second, third, and fourth gears 341, 342, 351, 352 is a bevel gear, the speed ratio of the first gear 341 to the second gear 342 is 0.8, and the speed ratio of the third gear 351 to the fourth gear 352 is 0.5, such that rotation of the driving member 32 will adequately drive the connecting rod 15 of the frame unit 1 to rotate.

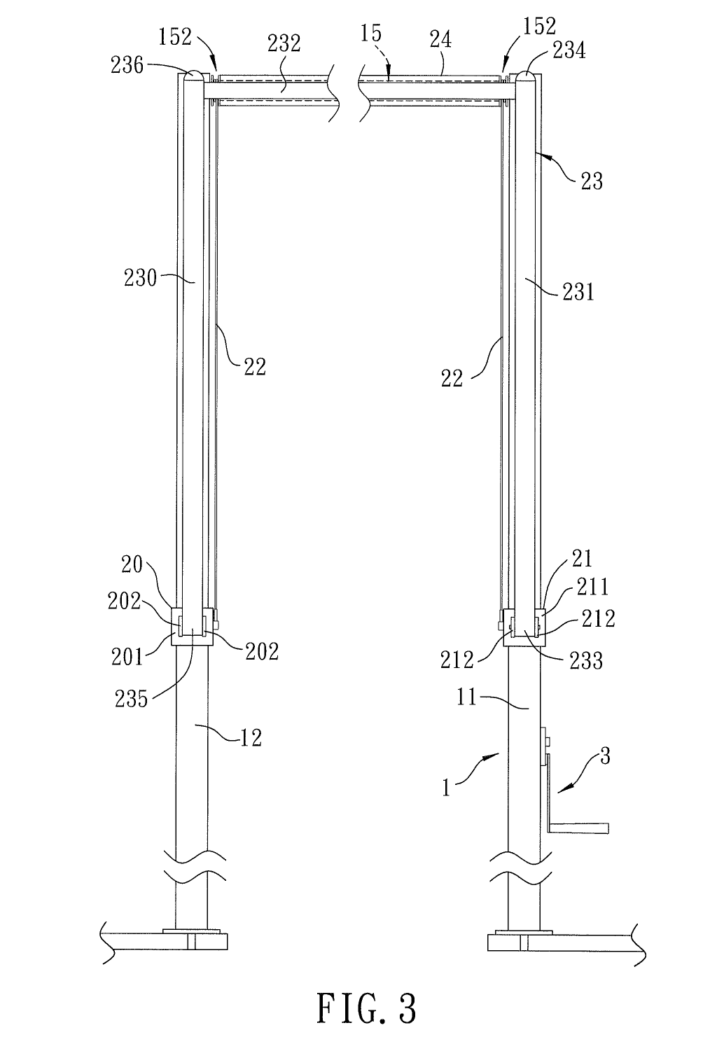

In use, referring to FIGS. 3, 4, and 6, when the handle section 323 of the driving member 32 of the driving mechanism 3 is operated to rotate clockwise, the driving member 32 is rotated clockwise along with the handle section 323, thereby driving the connecting rod 15 of the frame rod 1 to rotate in a first rotating direction 41 via engagement between the transmission shaft 33 and the first and second gear units 34, 35 of the driving mechanism 3. During the rotation of the connecting rod 15, the connecting components 22 of the driven mechanism 2 are wound and respectively on the engaging portions 152 of the connecting rod 15, such that the first and second movable seats 21, 20 of the driven mechanism 2 are drawn to move upwardly and respectively along the first and second upright posts 11, 12 of the frame unit 1. As the first and second movable seats 21, 20 move, the pivot ends 233, 235 of the first and second side rods 231, 230 of the supporting units 23 of the driven mechanism 2 move uprightly and respectively along with the first and second movable seats 21, 20 so as to drive the supporting units 23 to pivot relative to the first and second movable seats 21, 20 while the linking rods 232 are moved away from the connecting rod 15. Finally, the first and second side rods 231, 230 of the supporting units 23 are pivoted to positions transverse to the first and second upright posts 11, 12, thereby changing the driven mechanism 2 to the unfolded state. At this time, the tent covers 24 are unwound due to the rotation of the connecting rod 15 and the pivoting movement of the supporting units 23.

After use, the handle section 323 of the driving member 32 of the driving mechanism 3 is rotated counterclockwise to drive the connecting rod 15 to rotate in a second rotating direction 42 (see FIG. 2) opposite to the first rotating direction 41, such that the connecting components 22 of the driven mechanism 2 are unwound respectively from the engaging portions 152 of the connecting rod 15, thereby allowing the first and second movable seats 21, 20 to move downwardly. The downward movement of the first and second movable seats 21, 20 then causes the supporting units 23 to pivot reversely while the linking rods 232 are pivoted to positions adjacent to the connecting rod 15, thereby converting the driven mechanism 2 to the folded state. Simultaneously, the tent covers 24 are wound on the connecting rod 15 due to rotation of the connecting rod 15 and the pivoting movement of the supporting units

To sum up, the foldable tent of this invention can be unfolded and folded by simply rotating the driving member 32 of the driving mechanism 3 without disassembling the frame unit 1 and the tent covers 24. Therefore, the foldable tent of this invention is easier and more convenient to use than the aforementioned prior art.

It should be noted that, while the driving mechanism 3 is exemplified to be actuated manually, an electric driving mechanism may be employed in other embodiments of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A foldable tent comprising:
a frame unit including a first upright post, a second upright post that is spaced apart from said first upright post, and a connecting rod that extends in a first horizontal direction and that rotatably interconnects top ends of said first and second upright posts;
a driven mechanism includes
first and second movable seats disposed on and movable along said first and second upright posts, respectively,
a pair of elongate, flexible connecting components, each of which interconnects a respective one of said first and second movable seats and said connecting rod of said frame unit,
a pair of supporting units spaced apart from each other in a second horizontal direction transverse to the first horizontal direction, each of said supporting units including a first side rod that has a pivot end connected pivotally to said first movable seat and a connecting end opposite to said pivot end of said first side rod, a second side rod that is parallel to said first side rod, and that has a pivot end connected pivotally to said second movable seat and a connecting end opposite to said pivot end of said second side rod, and a linking rod that is parallel to said connecting rod of said frame unit and that interconnects said connecting ends of said first and second side rods, and
a pair of tent covers disposed on said frame unit, each of said tent covers having a first securing portion that is connected fixedly to said connecting rod of said frame unit, and a second securing portion that is connected fixedly to said linking rod of a respective one of said supporting units,
wherein said driven mechanism is convertible between an unfolded state, where said first and second movable seats are proximate to said connecting rod of said frame unit and where said connecting ends of said first and second side rods of said supporting units are far away from said connecting rod of said frame unit so as to unwind said tent covers, and a folded state, where said first and second movable seats are distal from said connecting rod of said frame unit and where said connecting ends of said first and second side rods are adjacent to said connecting rod of said frame unit so as to wind said tent covers on said connecting rod of said frame unit; and
a driving mechanism mounted on said frame unit for driving said connecting rod of said frame unit to rotate, thereby resulting in conversion of said driven mechanism between the unfolded and folded states.

2. The foldable tent as claimed in claim 1, wherein:
said first upright post of said frame unit includes a hollow post body defining a receiving space therein;
said connecting rod of said frame unit has opposite rod ends connected rotatably and respectively to said top ends of said first and second upright posts; and
said driving mechanism includes a driving member mounted on said first upright post and extending rotatably into said receiving space in said first upright post, a transmission shaft disposed uprightly and rotatably in said receiving space, a first gear unit connecting co-rotatably said driving member to a bottom end of said transmission shaft, and a second gear unit connecting co-rotatably a top end of said transmission shaft to a corresponding one of said rod ends of said connecting rod of said frame unit.

3. The foldable tent as claimed in claim 2, wherein said driving member of said driving mechanism has
a driving section having a first end that extends rotatably and horizontally into said receiving space in said post body of said first upright post of said frame unit, and that is connected to said first gear unit, and a second end that is exposed from said post body of said first upright post,
a connecting section extending uprightly from said second end of said driving section and having a distal end that is opposite to said driving section, and
a handle section extending horizontally from said distal end of said connecting section in a direction away from said driving section, and operable for driving said driving member to rotate.

4. The foldable tent as claimed in claim 2, wherein:
said first gear unit of said driving mechanism includes a first gear connected fixedly to said driving member, and a second gear connected fixedly to said bottom end of said transmission shaft and meshing with said first gear; and
said second gear unit of said driving mechanism includes a third gear connected fixedly to said top end of said transmission shaft, and a fourth gear connected fixedly to the corresponding one of said rod ends of said connecting rod of said frame unit and meshing with said third gear.

5. The foldable tent as claimed in claim 4, wherein each of said first, second, third, and fourth gears is configured as a bevel gear.

6. The foldable tent as claimed in claim 1, wherein:
said connecting rod of said frame unit has opposite rod ends connected rotatably and respectively to said first and second upright posts, a main rod portion disposed between said first and second upright posts, and a pair of engaging portions, each of which is disposed between said main rod portion and a respective one of said rod ends and is disposed proximate to the respective one of said rod ends; and
each of said connecting components of said driven mechanism has a first section connected to the respective one of said first and second movable seats, and a second section connected to a respective one of said engaging portions of said connecting rod of said frame unit.

7. The foldable tent as claimed in claim 6, wherein each of said engaging portions of said connecting rod of said frame unit includes a pair of outward flanges that are spaced apart from each other in the first horizontal direction, and that cooperatively define an annular groove for retaining said second section of the respective one of said connecting components therein.

8. The foldable tent as claimed in claim 1, wherein:
said first movable seat of said driven mechanism has a sleeve portion sleeved movably on said first upright post of said frame unit, and a pair of pivot lug portions projecting respectively from opposite sides of said sleeve portion of said second movable seat in the second horizontal direction and connected pivotally and respectively to said pivot ends of said first side rods of said supporting units of said driven mechanism; and
said second movable seat of said driven mechanism has a sleeve portion sleeved movably on said second upright post of said frame unit, and a pair of pivot lug portions projecting respectively from opposite sides of said sleeve portion in the second horizontal direction and connected pivotally and respectively to said pivot ends of said second side rods of said supporting units.
